(19) United States
(12) Patent Application Publication
(10) Pub. No.: US 2015/0221028 A1
(43) Pub. Date: Aug. 6, 2015

(54) METHOD AND APPARATUS FOR VALUE INTERCHANGE PRICING

(71) Applicant: MasterCard International Incorporated, Purchase, NY (US)

(72) Inventors: Brigette White, Cortland Manor, NY (US); Denise Torreyson, Elmsford, NY (US); Steven J. Jonas, Westport, CT (US)

(21) Appl. No.: 14/689,905

(22) Filed: Apr. 17, 2015

Related U.S. Application Data
(63) Continuation of application No. 13/152,858, filed on Jun. 3, 2011.
(60) Provisional application No. 61/351,163, filed on Jun. 3, 2010.

(51) Int. Cl. G06Q 40/02; G06Q 20/34

(52) U.S. Cl. CPC G06Q 40/02; G06Q 20/34

(57) ABSTRACT

Methods, systems and computer readable media for determining an interchange tier to apply to individual payment card accounts. In an embodiment, a payment card system operator computer establishes scoring rules and at least two interchange tiers to associate with payment card accounts, transmits the scoring rules to at least one issuer, receives payment card account data, and scores each of the plurality of individual payment card accounts, and scores each of the payment card accounts according to the scoring rules. The process also includes assigning an interchange tier to each of the plurality of individual payment card accounts in accordance with the scoring, and storing information indicating the interchange tier associated with each of the plurality of individual payment card accounts for use during purchase transactions in a tier and scoring database.

### CROSS-REFERENCE TO RELATED APPLICATION

This application claims the benefit of and priority to U.S. patent application Ser. No. 13/152,858 filed on Jun. 3, 2011, which claims the benefit of U.S. Provisional Patent Application No. 61/351,163 filed Jun. 3, 2010, which applications are incorporated herein by reference in their entirety for all purposes.

### FIELD OF THE INVENTION

Embodiments relate to payment card processing systems and methods. More particularly, embodiments relate to methods and systems for determining transaction pricing.

### BACKGROUND

Embodiments disclosed herein relate to payment systems. In particular, some embodiments relate to methods, apparatus, systems, means and computer program products for value-based interchange pricing in a payment processing network.

Payment cards are frequently used to pay for goods and services. One of the best known payment card systems is operated by MasterCard International Incorporated, which is the assignee hereof. As is very well known, cardholders present payment cards at point of sale terminals, or otherwise provide their payment card account numbers to merchants, in order to pay for purchase transactions.

Payment cards are issued by financial institutions such as banks to individual cardholders and to businesses and other entities. These financial institutions are referred to as issuers. The issuers of the payment cards maintain the payment card accounts of the cardholders.

Another class of participants in a payment card system is referred to as the “acquirers”. These are financial institutions which have relationships with merchants who accept payment cards in as payment for transactions entered into by cardholders. Acquirers in substance serve as the merchants' point of contact with the payment card system. To initiate transactions in the payment card system, merchants accept payment cards and transmit authorization requests to acquirers.

The operator of the payment card system (e.g., the assignee hereof) is sometimes referred to as the “payment card system operator” or just the “operator”. The payment card system operator operates a payment processing system that receives authorization requests for purchase transactions from the acquirers and routes the requests to the issuers of the payment cards. An example of a payment processing system is the “Banknet” system, which is operated by the assignee hereof. The payment card system operator also operates a clearing system by which settlement of transactions occurs between issuers and acquirers.

One aspect of a typical payment card system is referred to as “interchange”. An interchange fee is a small fee paid by the acquirer to the issuer with respect to a particular transaction. The purpose of the interchange fee is to compensate the issuer for a portion of the risks and costs it incurs. Interchange rates/fees are only one of the many cost components of the “merchant discount rates” that are paid by merchants in exchange for card acceptance services provided by acquirers to merchants.

Interchange rates may in some cases be established on the basis of a bilateral agreement between an issuing bank and an acquiring bank. However, for many transactions in a payment card system, the interchange fee for a particular transaction is based on a “default” interchange rate established by the payment card system operator. Such interchange rates are “default” in the sense that they apply in the absence of a bilateral agreement between the issuer and the acquirer bank.

Interchange fees are a necessary and efficient method for maintaining a strong and vibrant payment card system. Setting interchange rates is a challenging proposition that involves an extremely delicate balance. If interchange rates are set too high, such that they lead to disproportionately high merchant discount rates, then merchants' desire and demand to accept a particular brand of payment card may be reduced. However, if interchange rates are set too low, then issuers' willingness to issue and promote the brand of payment cards will be reduced, and cardholders' demand for the brand of payment cards will also be reduced. In response to these competitive forces, a payment card system operator may strive to maximize the value of the payment card system (including total dollars spent with the system's cards, the number and types of cards in circulation, and the number and types of merchants accepting the system's cards) by setting default interchange rates at levels that balance the benefits and costs to both cardholders and merchants.

In a typical arrangement, the payment card system operator publishes interchange rates that apply to various categories of transactions. During the process of clearing the transactions, the acquirers determine which rates apply to the transactions based on information about the transactions received from the merchants.

A published set of interchange rates may apply, for example, to transactions submitted by merchants in the United States and charged to payment card accounts issued in the United States. Another set of interchange rates may apply to transactions submitted by merchants in the United States and charged to payment card accounts issued outside of the United States. Similarly, other sets of interchange rates may apply to transactions submitted by merchants in other countries, based on payment card accounts issued in those countries or outside of those countries.

Interchange rate tables may be organized by the type of card product under which the payment card account is issued. Each interchange rate may have a series of requirements, all of which must be satisfied in order for a transaction to qualify for that rate. The requirements may include such factors as: merchant category; the time between authorization and clearing; the presence or absence of magnetic stripe data; the submission of enhanced transaction data; and a merchant's sales and transaction volume in the payment card system. In some cases the transaction amount for the particular transaction must be above or below a particular transaction amount threshold for the transaction to qualify for a particular interchange rate.

Examples of merchant categories are restaurant, airline, vehicle rental, convenience stores, and fuel dispenser. There are many other merchant categories in use for establishing interchange rates.

Typically an interchange rate is composed of one or both of two components, namely a percentage of the transaction amount and a flat per transaction charge. A typical percentage amount for an interchange rate may be in the range of 1.5% or 2.0% (although higher or lower percentage amounts may apply in some cases). A typical flat per transaction charge may be $0.05 to $0.10. Thus, for example, certain transactions may qualify for an interchange rate of 1.55%+$0.10, whereas other transactions may qualify for an interchange rate of 1.90%+$0.05. Many other combinations of percentage plus flat fee are in use. A percentage alone without flat fee is also applicable to some categories of transactions. Also, for example, some interchange rates may simply be a flat fee such as $0.75. For some categories, an interchange rate that includes a percentage (with or without a flat charge component) may be subject to a minimum fee floor and/or a maximum fee ceiling per transaction.

The assignee of the present application has previously proposed (as set forth in U.S. patent application Ser. No. 12/574,822 filed on Oct. 7, 2009, the contents of which are incorporated herein by reference in their entirety for all purposes) a dynamic approach to interchange pricing in which dynamic interchange rates may be established on a per-account basis depending on, e.g., an account's spending history.

Applicants have discovered further techniques for establishing dynamic interchange pricing which are based on a payment account's relative or actual value. In some embodiments, as will be described further herein, a number of rate tiers are established. Each of the tiers is assigned a minimum value score to qualify for the interchange pricing at that tier. The value score is based on, for example, a number of value-related variables which reward an issuer for identifying accounts that, by virtue of their spending behavior and other characteristics, can earn higher interchange. For example, a value score may be based on or influenced by accounts which involve a high annual spend or accounts which involve a desired level of spend in addition to other account characteristics which are desirable (e.g., such as account features such as rewards, APR, purchase assurance, or the like). In general, the variables or characteristics may be selected to identify accounts that, by virtue of their spending behavior and other characteristics, present a fraud and risk profile that allows them to qualify for higher interchange tiers.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, which illustrate preferred and exemplary embodiments and which are not necessarily drawn to scale, wherein:

FIG. 1 is a block diagram that illustrates a payment card system in which the present invention may be applied.

FIG. 2 is a block diagram that illustrates additional details of the payment card system of FIG. 1.

FIG. 3 is a simplified block diagram of a server computer that is operated by a payment card system operator as part of the system of FIG. 1.

FIG. 4 is a flow chart that illustrates a process that may be performed in accordance with aspects of the present invention by the payment card system operator server computer of FIG. 3.

### DETAILED DESCRIPTION

In general, and for the purpose of introducing concepts of embodiments of the present invention, embodiments relate to payment card systems in which an interchange fee is assessed to transactions. In previous systems, to the extent that interchange rates were based on the identity of the payment card account, the interchange rates were based on static attributes, such as the type of card product issued for that account. Embodiments of the present invention introduce systems and methods for determining and assessing value-based interchange fees based on, for example, payment card account usage, features, and cardholder characteristics.

In some embodiments, systems, methods, apparatus, computer program code, and means for processing transactions are provided which include receiving transaction data associated with a payment transaction, said transaction data including a payment account identifier, the payment account identifier identifying a payment account, determining a value score associated with the payment account identifier, determining, based on the value score, an interchange tier associated with the payment account identifier, and providing an indication of the interchange tier to a clearing and settlement process involving the payment account identifier.

Pursuant to some embodiments, the use of tiers and scoring pursuant to the invention will enable the transactions of cardholders who exhibit merchant-positive behaviors to be eligible for higher interchange. In some embodiments, the tiered or value based approach of the present invention will be an optional process issuers can use to identify accounts that, by virtue of their spending behavior and other characteristics, can move into higher interchange tiers. In some embodiments, alternatives to the current fixed qualification requirements are offered in addition to the spend and/or benefit requirements of existing products. One aspect of some embodiments is the identification and quantification of the relationship of a card's attributes and benefits to overall cardholder spend and other key metrics, and this may be performed by the analysis of data from issuers that quantify the impact underwriting actions have on spend by segment. Analysis of such data will enable the identification of those elements that have the greatest impact on spend and establish relative value of those elements for each interchange tier. Pursuant to some embodiments, computer systems and processing are provided to allow the determination of a value score during the course of a transaction (or after completion of transaction process) so that an appropriate interchange tier may be identified and applied for each transaction. The result is a transaction processing system and method which dynamically identifies and applies an appropriate interchange amount for different transactions associated with different accounts.

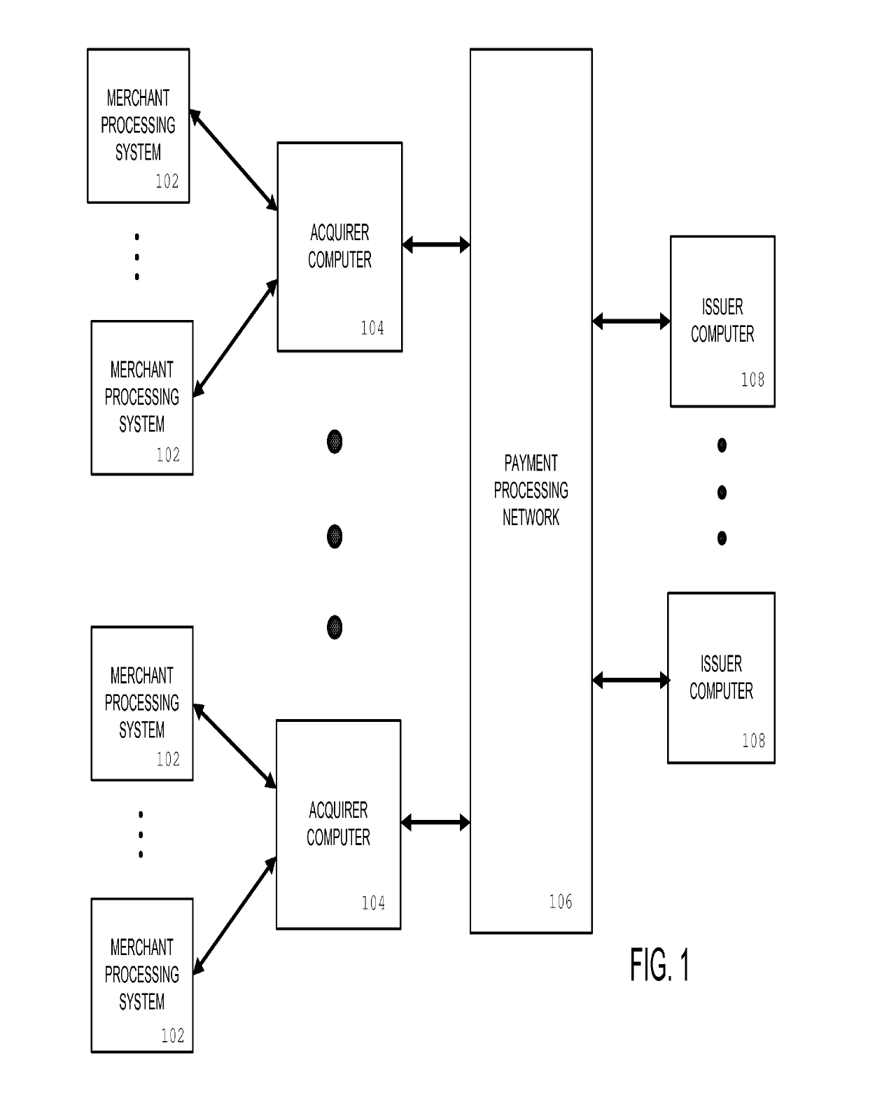

FIG. 1 is a block diagram that illustrates a payment card system 100 in which the present invention may be applied.

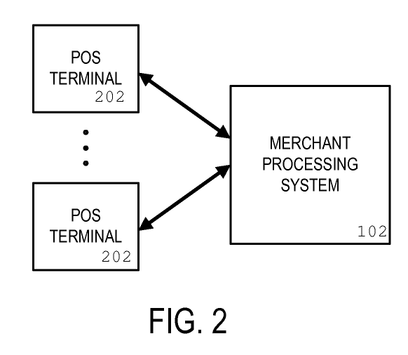

The payment card system 100 includes numerous merchant processing systems 102. Each merchant processing system 102 is a computer or computer system that receives transaction data from the POS locations (indicated by reference numerals 202 in FIG. 2) connected to it and that forwards authorization requests and requests to settle purchase transactions to an acquirer computer 104. In the case of an internet shopping site, the POS location(s) and the merchant processing system may be integrated together into a single computer system. In some cases (not illustrated), the POS location 202 may communicate directly with an acquirer computer 104, without an intervening merchant processing system.

The term “acquirer” is widely used in the payment processing field, and refers to financial institutions such as banks or other financial systems that have agreements with merchants to receive and forward authorization and settlement messages in connection with payment card payments received by those the merchants. The term “acquirer” also refers to processing agents that act on behalf of such financial institutions or systems. Each acquirer typically serves numerous merchants, and accordingly each acquirer computer 104 is shown as being in communication with numerous merchant processing systems 102. Moreover, a typical payment card system involves numerous acquirers, and FIG. 1 therefore schematically shows numerous acquirer computers 104.

As will be understood from FIGS. 1 and 2, taken together, the payment card system 100 includes numerous POS locations 202 (FIG. 2). The term “POS location” refers to “points of transaction” such as internet commerce sites that receive payment account numbers from customers who shop online, mail order or telephone (MOTO) merchants who receive payment account numbers by telephone and/or mail, merchants who submit recurring payments pursuant to agreements with cardholders and physical point of sale terminals located in brick-and-mortar retail stores. In the case of physical point of sale terminals, a payment card (not shown; e.g., a credit card, debit card, charge card, stored value card, or a corporate card or fleet card) is presented at the terminal by a customer and read by the terminal to input, among other things, the number of the payment card account to which a purchase transaction is to be charged. In the case of other types of POS location, the payment card account number is input into the POS location by human data entry or other means.

In addition to the acquirer computers 104, the payment card system 100 includes a payment processing network 106, such as the above-mentioned Banknet system. The payment processing network 106 is constituted by one or more computers operated by the payment card association, and related data communication facilities (not separately shown). The payment processing network 106 is in communication, at least from time to time, with the acquirer computers 104. The payment processing network 106 receives transaction authorization requests from acquirers and passes the authorization requests to issuers of payment cards. The payment processing network 106 also returns authorization responses to the acquirers from the issuers.

The payment card system operator may also operate a transaction clearing system, such as the well known Global Clearing Management System (GCMS), also operated by the assignee hereof. The transaction clearing system is not shown apart from the payment processing network 106. The transaction clearing system, like the payment processing network 106, may be constituted by one or more computers operated by, and associated communication facilities commissioned by, the payment card system operator. The transaction clearing system receives purchase transaction clearing requests, typically in batches, from the acquirer computers 104. However, in an alternative embodiment, the payment card system operator computer(s) which handle(s) authorization requests and responses may be integrated with the transaction clearing system computer(s).

The above description relates primarily to a so-called “two message” system, in which an authorization request/response is later followed by a clearing message. However, payment card systems may also operate on a “one message” basis in which authorization and clearing are performed simultaneously in a single round of request and response.

FIG. 1 also shows, as part of the payment card system 100, issuer computers 108. Issuer computers 108 are operated by financial institutions that have issued the payment cards used by cardholders in connection with the payment card system 100.

In the case of MasterCard International Incorporated, numerous issuers participate in the MasterCard payment card system, and accordingly numerous issuer computers 108 are schematically shown as being in communication with the payment processing network 106. As is well-known, the issuers maintain payment card accounts of the cardholders. Clearing messages received by the issuer computers 108 from the payment card system clearing system (not shown apart from payment processing network 106) indicate (typically in batches) transactions that are to be charged by the issuers to the cardholders' accounts.

In some embodiments, issuer computers 108 collect, aggregate or otherwise report information about different payment card accounts issued by the issuer, including information identifying product types (such as a basic credit product, an enhanced credit product, credit products targeted to high income and cardholders, etc.). In addition, issuers may collect, aggregate or otherwise report information about spending attributes of each payment card account as well as the features associated with each payment card account (e.g., such as whether the account has features that tend to indicate a higher value such as purchase assurance, identity theft resolution, rewards, etc.). Each payment card account may be “scored” based on whether one or more required elements or values are present (such as, for example, a minimum spend, cardholder demographics such as a minimum income level, a minimum size of credit line, and a number of monthly transactions), and whether one or more optional elements are present (such as rewards, and other card or account features). The issuer may track and provide this information to the payment processing network 106 for use in determining which interchange tier a given payment card account is eligible for. Identification of the required and optional elements may be performed by the payment processing network 106 and communicated to individual issuers so the issuers can track and provide the required information.

Pursuant to some embodiments, issuers provide such information on an initial basis when they choose to use the interchange tiers of the present invention. In some embodiments, the issuer may simply certify or self-assess accounts based on tier information and rules provided by the payment card system operator. In some embodiments, the payment card system operator may review or recertify the classification of accounts on an annual or other regular basis.

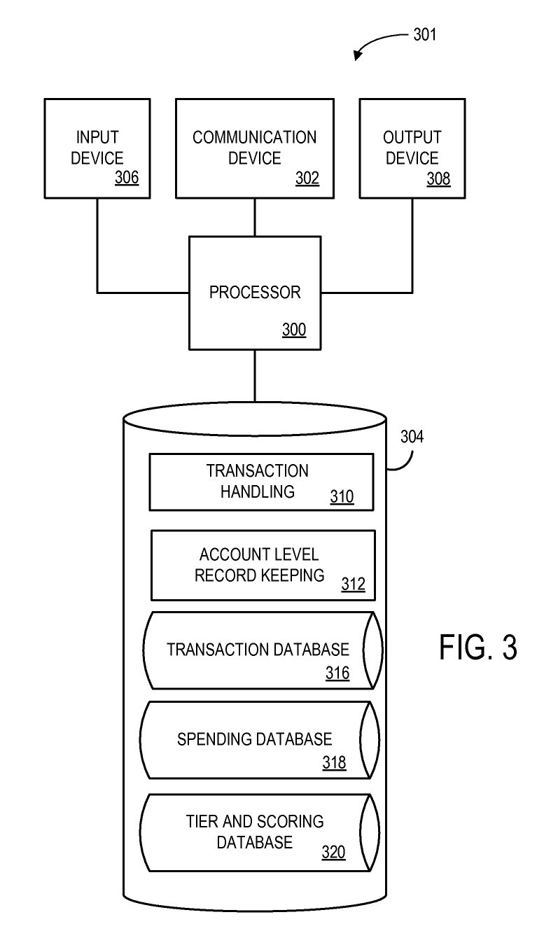

FIG. 3 is a simplified block diagram of a server computer 301 that is operated by a payment card system operator as part of the payment card system 100. The server computer 301 (hereinafter referred to as a “payment card system operator computer”) may in practice be constituted by one computer or two or more cooperating computers, and may perform functions normally provided by the payment card system operator in conjunction with a payment card system. From previous discussion it will be understood that these functions may include routing of authorization requests and authorization responses, and clearing of transactions in the payment card system 100.

Further, in a related (and, in some embodiments, separate) aspect of some embodiments, the payment card system operator computer 301 may perform functions related to accumulating spending history information and providing indications of such information to acquirers for use by the acquirers in determining what interchange rates are to be applied to purchase transactions in the payment card system 100 (e.g., as described in conjunction with co-pending and commonly assigned U.S. patent application Ser. No. 12/574,822 filed on Oct. 7, 2009).

The payment card system operator computer 301 may, in accordance with some embodiments of the present invention, perform functions relating to the determination of an interchange tier based on payment card account scoring data received from issuers. The determination of an interchange tier may be performed on an annual basis with data provided by one or more participating issuers. In some embodiments, issuers may score or identify the appropriate interchange tier for each of their participating accountholders. The issuer scoring and tiering may be recertified or audited on a regular basis by the payment card system operator. In some embodiments, the selection, scoring and creation of the interchange tiers and scoring algorithms involves performing an analysis of payment card account characteristics to generate one or more scoring and pricing algorithms.

The payment card system operator computer 301 may be conventional in its hardware aspects but may be controlled by software to cause it to operate in accordance with aspects of the present invention.

The payment card system operator computer 301 may include a computer processor 300 operatively coupled to a communication device 302, a storage device 304, an input device 306 and an output device 308.

The computer processor 300 may be constituted by one or more conventional processors. Processor 300 operates to execute processor-executable steps, contained in program instructions described below, so as to control the payment card system operator computer 301 to provide desired functionality. The program instructions may be referred to as computer readable program code means.

Communication device 302 may be used to facilitate communication with, for example, other devices (such as the acquirer computers 104 and the issuer computers 108 shown in FIG. 1).

Input device 306 may comprise one or more of any type of peripheral device typically used to input data into a computer. For example, the input device 306 may include a keyboard and a mouse. Output device 308 may comprise, for example, a display and/or a printer.

Storage device 304 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be referred to as a computer usable medium.

Storage device 304 stores one or more programs for controlling processor 300. The programs comprise program instructions that contain processor-executable process steps of payment card system operator computer 301, including, in some cases, process steps that constitute processes provided in accordance with principles of the present invention, as described in more detail below.

The programs may include an application 310 that programs the payment card system operator computer 301 to handle authorization requests and clearing for transactions in the payment card system 100. The payment card system operator computer 301 may handle the transactions generally in accordance with conventional practices, except that, in addition, the payment card system operator computer 301 may utilize data identifying the relevant tier a payment account is categorized in when clearing a transaction involving the payment account (e.g., by applying the interchange associated with the relevant tier).

In addition the programs stored in the storage device 304 may include an application 312 that programs the payment card system operator computer 301 to keep track—on an account-by-account basis—of purchase transactions performed in the payment card system 100 for each payment card account (or at least for each account in a subset of the payment card accounts).

Storage device 304 may also store a database 316 that contains data relating to transactions handled in the payment card system 100. In some embodiments, the transaction database may take the form of a data warehouse maintained in a separate computer (not separately shown) from the payment card system operator computer 301. The data warehouse may store, for each transaction cleared in the payment card system 100, information such as the transaction amount, the payment card account number for the payment card account to which the transaction was charged, and the merchant identifier (or at least merchant classification) for each transaction. In addition to this transaction information, the data warehouse/transaction database 316 may include any and all transaction data required for subsequent audit of the transactions cleared through the payment card system 100.

Another database that may be stored in the storage device 304 is a spending history database 318. The spending history database may contain account-by-account cumulative purchase information compiled by the account level record keeping program 312 from data stored in the transaction database/data warehouse 316.

Pursuant to some embodiments, a tier and scoring database 320 is also stored in the storage device 304. For example, the payment card system operator computer 301 may store tier and scoring data 320 which is used to determine which interchange tier a payment card account is eligible to receive in a given transaction. In some embodiments, the interchange tiers associated with individual payment card accounts are determined on a regular (such as annual basis). In some embodiments, the interchange tier a card is eligible for is determined by the payment card issuer based on rules and criteria provided to the issuer. In some embodiments, the interchange tier a card is eligible for is determined by the payment card system operator using data provided by the issuer in conjunction with data possessed by the payment card system operator.

Examples of the type of data and information that may be stored in tier and scoring database 320 are shown below. In the first table, a number of required elements are shown for each of a number of interchange tiers. That is, for a payment card account to be eligible to receive the interchange pricing of “Tier 1”, the payment card account must satisfy all of the required elements and metrics defined in the table. Each of the required metrics in the embodiment shown below are valued at “50 points” each for a total of 200 points to qualify for a particular tier (those skilled in the art will appreciate that other point or scoring systems may be used, and the system shown below is for illustrative purposes only). For example, in Tier 1, the spend level may be $10,000 annually for a payment card, while in Tier 2, the spend level may be $20,000. A number of required elements may be specified and each “tier” of interchange pricing will include higher metrics (so that to qualify for a higher tier, a higher “value” must be provided by the account). In some embodiments, the required elements may be identified as being at either an account (or “PAN”) level or at a “portfolio level” (where a portfolio is a group of payment cards issued by an issuer. In the example data below, a payment card meets the requirements for Tier 2 pricing if the payment card account has a total of 200 points, which may be met if an account has a spend of >$x, a consumer demographic greater than or equal to “Value1A”, an account parameter A1 greater than or equal to “Value1A1”, etc.

| | REQUIRED | | PAN | PORTFOLIO | POINT |
|---|---|---|---|---|---|
| TIER | ELEMENTS | METRIC | LEVEL? | LEVEL? | VALUE |
| Tier | Spend | $x | Yes | No | 50 |
| 1 | Consumer | Value | Yes | No | 50 |
| | Demographic | 1A | | | |
| | A | | | | |
| | Account | Value | Yes | No | 50 |
| | Parameter A1 | 1A1 | | | |
| | Transaction | Value | Yes | No | 50 |
| | Parameter A2 | 1A2 | | | |
| Tier | Spend | $y | Yes | No | 50 |
| 2 | Consumer | Value | Yes | No | 50 |
| | Demographic | 1B | | | |
| | A | | | | |
| | Account | Value | Yes | No | 50 |
| | Parameter A1 | 1B1 | | | |
| | Transaction | Value | Yes | No | 50 |
| | Parameter A2 | 1B2 | | | |
| . . . | . . . | . . . | . . . | . . . | . . . |

In the second table, shown below, a number of “optional elements” for each tier are shown. These optional elements may be combined in order to make-up for having insufficient points to meet the Tier requirements. The optional elements, for example, may have lower “point values” than the required elements, and in the example below, two optional elements must be provided to make up for the lack of one required element (although those skilled in the art will appreciate that other schemes and values may be used). The optional elements (and their associated metrics) may be selected based on an analysis of the relative value provided by each of the elements. The optional elements may include account-level features (such as whether the accounts have identity theft protection, etc.), and portfolio level features (such as rewards, etc.).

| | OPTIONAL | | PAN | PORTFOLIO | POINT |
|---|---|---|---|---|---|
| TIER | ELEMENTS | METRIC | LEVEL? | LEVEL? | VALUE |
| Tier | Rewards | Rewards | No | Yes | 25 |
| 1 | | value | | | |
| | Account | Value | Yes | Yes | 25 |
| | Option C1 | 1C1 | | | |
| | Account | Value | Yes | Yes | 25 |
| | Option C2 | 1C2 | | | |
| | Account | Value | Yes | Yes | 25 |
| | Option C3 | 1C3 | | | |
| | Portfolio | Value | No | Yes | 25 |
| | Option D1 | 1D1 | | | |
| | Portfolio | Value | No | Yes | 25 |
| | Option D2 | 1D2 | | | |
| | Portfolio | Value | No | Yes | 25 |
| | Option D3 | 1D3 | | | |
| . . . | . . . | . . . | . . . | . . . | . . . |

Pursuant to some embodiments, a number of different “required” elements may be provided which are selected, for example, based on their direct relationship or impact on cardholder spending using a payment card. A number of different “optional” elements may also be provided. The “optional” elements, in some embodiments, may be selected based on their indirect relationship or impact on cardholder spending. In some embodiments, where the required or optional metric is measured at the “portfolio” level, a threshold amount may be specified for the portfolio. For example, in embodiments where the use of “PayPass” or other RFID technologies is specified as an optional element at a portfolio level, an issuer must certify or otherwise indicate that the portfolio that a particular account is in has a minimum percentage or amount of cards that use PayPass. For example, a metric may specify that a portfolio have more than 50% of its cards as PayPass cards in order to earn the optional points for that metric in a given tier.

There may also be stored in storage device 304 other unshown elements that may be necessary for operation of the payment card system operator computer 301, such as an operating system, a database management system, communication software, other applications, other data files, device drivers, etc.

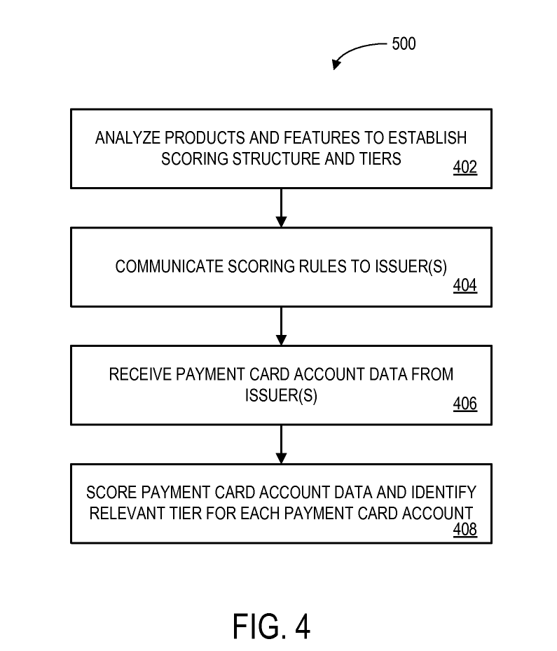

FIG. 4 is a flow chart that illustrates a process performed in accordance with aspects of the present invention by the payment card system operator computer 301.

Some or all of the processing of FIG. 4 may be performed on an ongoing basis (e.g., as value scoring changes, as issuers identify portfolios, etc.). In some embodiments, the processing may be performed on a regular or scheduled basis (e.g., such as on an annual basis). Processing at 402 includes operating a payment card system operator computer 301 to analyze products and features to establish one or more scoring structures and tiers. For example, the processing at 402 may result in the creation of one or more tables (as shown above in conjunction with FIG. 3) which may be used to score or analyze individual payment accounts to identify the appropriate interchange tier that a given payment account is eligible to receive.

Processing continues at 404 where the scoring rules are communicated to one or more issuer(s) participating in the system of the present invention. The issuer(s) use the scoring rules to provide data to be used in the scoring system. For example, information about individual payment card accounts may be provided (e.g., such as the annual spend, consumer demographics, etc. for use in assessing an individual payment account and whether it meets one or more of the required or optional elements), as well as information about particular portfolios managed by the issuer (e.g., to identify whether a particular payment account is in a portfolio and whether that portfolio meets any portfolio level requirements for a given interchange tier). In some embodiments, rather than providing the scoring rules to an issuer, the issuer may instead provide any required data to the a payment card system operator computer 301 for analysis.

Processing continues at 406 where the payment card account data is received from the participating issuer(s). This data may be provided in a batch basis or in real time in response to requests from the payment card system. Processing continues at 408 where the computer scores payment card account data and identifies the relevant interchange tier for each payment card account. The tier information is then used during transaction processing to assess the appropriate level of interchange to transactions involving each participating payment card account. In some embodiments, the tier associated with each payment card account is then used during clearing processing to ensure that the appropriate interchange amount for that card is applied to each transaction involving the card.

The above description and/or the accompanying drawings are not meant to imply a fixed order or sequence of steps for any process referred to herein; rather any process may be performed in any order that is practicable, including but not limited to simultaneous performance of steps indicated as sequential.

Those who are skilled in the art will appreciate the distinction between an “interchange fee” and an “interchange rate”. The former is a dollar amount of a fee that is charged to an acquirer for a particular transaction and is calculated by applying the latter (the “interchange rate”) to the transaction amount (in the case where the interchange rate is at least partially expressed in percentage terms). Thus the interchange rate may be at least partially expressed in terms of “percentage points”, where for example 1.7% is 1.7 percentage points, 1.9% is 1.9 percentage points, etc., and 1.7 is a different number of percentage points from 1.9.

It will also be understood that “transaction amount” refers to the dollar (or other currency) amount that is to be charged to a payment card account in connection with a particular purchase or other transaction in a payment card system.

The terms “payment card account” and “payment account” may be used interchangeably herein. Also, the term “payment transaction” may be used as a synonym for a purchase or other transaction carried out in a payment card system. A payment card account number is an example of a payment account identifier.

As used herein and in the appended claims, the term “payment card system account” includes: (i) a credit card account or (ii) a deposit account that the account holder may access using a debit card. The terms “payment card system account” and “payment card account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, stored value card, prepaid card, charge card, corporate card, fleet card, or any similar device or number used by cardholders in connection with payment transactions.

As used herein and in the appended claims, the term “payment card system” refers to a system for handling purchase transactions and related transactions and operated under the name of MasterCard, Visa, American Express, Diners Club, Discover Card or a similar system. In some embodiments, the term “payment card system” may be limited to systems in which member financial institutions issue payment card accounts to individuals, businesses and/or other organizations.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method for determining an interchange tier to apply to individual payment card accounts, comprising:
establishing, by a payment card system operator computer, scoring rules and at least two interchange tiers to associate with payment card accounts of participating issuer financial institutions based on an analysis of payment card account products and features;
transmitting, by the payment card system operator computer to at least one issuer computer of at least one participating issuer, the scoring rules and information characterizing the at least two interchange tiers;
receiving, by the payment card system operator computer from the at least one issuer computer, payment card account data of a plurality of individual payment card accounts and portfolio information regarding portfolios managed by the at least one participating issuer;
scoring, by the payment card system operator computer, each of the plurality of individual payment card accounts of the at least one participating issuer in accordance with the scoring rules and the portfolio information;
assigning, by the payment card system operator computer, an interchange tier to each of the plurality of individual payment card accounts in accordance with the scoring; and
storing, by the payment card system operator computer in a tier and scoring database, information indicating the interchange tier associated with each of the plurality of individual payment card accounts for use during purchase transactions.

2. The method of claim 1, further comprising:
receiving, by the payment card system operator computer from an acquirer computer, purchase transaction data including a payment account identifier identifying an individual payment card account of a participating issuer;
retrieving, by the payment card system operator computer from the tier and scoring database, the stored interchange tier associated with the individual payment card account associated with the payment account identifier, required elements of the payment card account, and at least one additional feature associated with the individual payment card account;
calculating, by the payment card system operator computer, a value score based on the retrieved required elements and the at least one additional feature;
determining, by the payment card system operator computer based on the value score and the retrieved interchange tier, an updated interchange tier; and
utilizing, by the payment card system operator computer, the updated interchange tier to process the purchase transaction.

3. The method of claim 2, further comprising transmitting, by the payment card system operator computer to a transaction clearing system, an indication of the updated interchange tier for use in a settlement process involving the payment account identifier and the payment transaction.

4. The method of claim 2, wherein the at least one required elements of the payment card account used to calculate the value score comprises at least one of minimum spend data, cardholder demographics data, minimum income level data, minimum credit line data, and monthly transactions data.

5. The method of claim 2, wherein the at least one payment card account feature used to calculate the value score comprises at least one of a purchase assurance feature, an identity theft feature, and a rewards feature.

6. The method of claim 1, wherein the payment card account products and features used to establish the scoring rules and at least two interchange tiers comprises at least one of basic credit product information and enhanced credit product information.

7. The method of claim 1, further comprising, prior to establishing the scoring rules and the at least two interchange tiers to associate with the payment card accounts, receiving, by the payment card system operator computer from an issuer computer, interchange tier information.

8. The method of claim 7, wherein the interchange tier information comprises at least one of individual spending attributes associated with each individual payment card account and features associated with each individual payment card account.

9. The method of claim 1, further comprising reassessing, by the payment card system operator computer, the interchange tier associated with each of the plurality of individual payment card accounts on a regular basis.

10. A system for determining an interchange tier to apply to individual payment card accounts, comprising:
a payment card system operator computer operably connected to a tier and scoring database;
a plurality of issuer computers associated with a plurality of payment card account issuer financial institutions; and
a plurality of acquirer computers associated with a plurality of merchant acquirer financial institutions;
wherein the tier and scoring database comprises instructions configured to cause the payment card system operator computer to:
establish scoring rules and at least two interchange tiers to associate with payment card accounts of participating issuer financial institutions based on an analysis of payment card account products and features;
transmit the scoring rules and information characterizing the at least two interchange tiers to at least one of the plurality of issuer computers;
receive payment card account data of a plurality of individual payment card accounts and portfolio information associated with the individual payment card accounts of a participating issuer from the at least one of the plurality of issuer computers;
score each of the plurality of individual payment card accounts of the at least one participating issuer in accordance with the scoring rules and the portfolio information;
assign an interchange tier to each of the plurality of individual payment card accounts in accordance with the scoring; and
store information indicating the interchange tier associated with each of the plurality of individual payment card accounts in the tier and scoring database for use when contacted by at least one of the plurality of acquirer computers during a purchase transaction.

11. The system of claim 10, wherein the tier and scoring database comprises further instructions configured to cause the payment card system operator computer to:
receive purchase transaction data from an acquirer computer, the purchase transaction data including a payment account identifier identifying an individual payment card account of a participating issuer;
retrieve the stored interchange tier associated with the individual payment card account associated with the payment account identifier, required elements of the payment card account, and at least one additional feature associated with the individual payment card account from the tier and scoring database;
calculate a value score based on the retrieved required elements and the at least one additional feature;
determine an updated interchange tier based on the value score and the retrieved interchange tier; and
utilize the updated interchange tier to process the purchase transaction.

12. The system of claim 11, wherein the tier and scoring database comprises further instructions configured to cause the payment card system operator computer to transmit an indication of the updated interchange tier to a transaction clearing system for use in a settlement process involving the payment account identifier and the payment transaction.

13. The system of claim 10, wherein the tier and scoring database comprises further instructions configured to cause the payment card system operator computer to, prior to establishing the scoring rules and the at least two interchange tiers, receive interchange tier information from an issuer computer that comprises at least one of individual spending attributes associated with each individual payment card account and features associated with each individual payment card account.

14. The system of claim 10, wherein the tier and scoring database comprises further instructions configured to cause the payment card system operator computer to reassess the interchange tier associated with each of the plurality of individual payment card accounts on a regular basis.

15. A computer readable medium storing non-transitory instructions configured to cause a payment card system operator computer processor to:
establish scoring rules and at least two interchange tiers to associate with payment card accounts of participating issuer financial institutions based on an analysis of payment card account products and features;
transmit the scoring rules and information characterizing the at least two interchange tiers to at least one of the plurality of issuer computers;
receive payment card account data of a plurality of individual payment card accounts and portfolio information associated with the individual payment card accounts of a participating issuer from the at least one of the plurality of issuer computers;
score each of the plurality of individual payment card accounts of the at least one participating issuer in accordance with the scoring rules and the portfolio information;
assign an interchange tier to each of the plurality of individual payment card accounts in accordance with the scoring; and
store information indicating the interchange tier associated with each of the plurality of individual payment card accounts in the tier and scoring database for use when contacted by at least one of the plurality of acquirer computers during a purchase transaction.

16. The computer readable medium of claim 15, further comprising non-transitory instructions configured to cause the payment card system operator computer processor to:
receive purchase transaction data from an acquirer computer, the purchase transaction data including a payment account identifier identifying an individual payment card account of a participating issuer;
retrieve the stored interchange tier associated with the individual payment card account associated with the payment account identifier, required elements of the payment card account, and at least one additional feature associated with the individual payment card account from the tier and scoring database;
calculate a value score based on the retrieved required elements and the at least one additional feature;
determine an updated interchange tier based on the value score and the retrieved interchange tier; and
utilize the updated interchange tier to process the purchase transaction.

17. The computer readable medium of claim 16, further comprising non-transitory instructions configured to cause the payment card system operator computer processor to transmit an indication of the updated interchange tier to a transaction clearing system for use in a settlement process involving the payment account identifier and the payment transaction.

18. The computer readable medium of claim 15, further comprising non-transitory instructions configured to cause the payment card system operator computer processor to, prior to establishing the scoring rules and the at least two interchange tiers, receive interchange tier information from an issuer computer that comprises at least one of individual spending attributes associated with each individual payment card account and features associated with each individual payment card account.

19. The computer readable medium of claim 15, further comprising non-transitory instructions configured to cause the payment card system operator computer processor to reassess the interchange tier associated with each of the plurality of individual payment card accounts on a regular basis.
